(19) United States
(12) Patent Application Publication
(10) Pub. No.: US 2023/0261500 A1
(43) Pub. Date: Aug. 17, 2023

(54) LITHIUM BATTERY CHARGE-LIMITING APPARATUS

(71) Applicant: POWERGENE TECHNOLOGY CO., LTD., TAIWAN BRANCH, New Taipei City (TW)

(72) Inventors: Hui-Te HSU, New Taipei City (TW); Chi-Hsien CHEN, New Taipei City (TW); Shih-Wei TAI, New Taipei City (TW)

(21) Appl. No.: 17/674,270

(22) Filed: Feb. 17, 2022

(51) Int. Cl. H02J 7/00; H01M 10/46; H01M 10/42; H01M 10/0525

(52) U.S. Cl. CPC H02J 7/007182; H02J 7/0071; H01M 10/46; H01M 10/4257; H01M 10/0525; H01M 2010/4278

(57) ABSTRACT

A lithium battery charge-limiting apparatus includes a microcontroller, a current detector, and an electronic switch. The current detector detects a consumption current of an electronic apparatus having a lithium battery and informs the microcontroller of the consumption current, so that the microcontroller learns a plurality of the consumption currents. The microcontroller determines a first amount of a plurality of slopes of the consumption currents. If a second amount in the first amount of the slopes of the consumption currents are between a first minus number and zero, and if a next slope of the slopes of the second amount of the consumption currents is greater than a present slope of the slopes of the second amount of the consumption currents, the microcontroller turns off the electronic switch to stop transmitting a charging voltage to the electronic apparatus.

### BACKGROUND OF THE DISCLOSURE

### Technical Field

The present disclosure relates to a lithium battery charging apparatus, and especially relates to a lithium battery charge-limiting apparatus.

### Description of Related Art

In recent years, smart phones, notebook computers, digital cameras and various portable electronic products have become more and more popular. Therefore, the lithium battery as a source of power has also attracted more and more attention.

The typical charging curve of a lithium battery usually includes a constant current (CC) mode and a constant voltage (CV) mode. In order to extend the cycle life of the lithium battery, the lithium battery is first charged in the constant current mode, and then the lithium battery is charged in the constant voltage mode.

General users always like the lithium battery to be fully charged, so that the portable electronic product may be used for a long time; however, according to various studies and statistics, if the lithium battery is always fully charged, the life of the lithium battery will be shortened.

Even though it is known that the lithium battery always being fully charged will shorten the life of the lithium battery, the charging habit often make the lithium battery be fully charged at the end, such as charging the lithium battery overnight; constantly checking the charging percentage of the lithium battery is also a very troublesome thing.

### SUMMARY OF THE DISCLOSURE

In order to solve the above-mentioned problems, an object of the present disclosure is to provide a lithium battery charge-limiting apparatus.

In order to achieve the object of the present disclosure mentioned above, the lithium battery charge-limiting apparatus of the present disclosure is applied to an electronic apparatus. The electronic apparatus includes a lithium battery. The lithium battery charge-limiting apparatus includes a microcontroller, a current detector, and an electronic switch. The current detector is electrically connected to the microcontroller. The electronic switch is electrically connected to the microcontroller. Moreover, when the lithium battery charge-limiting apparatus is configured to operate in a charge-limiting mode, the current detector is configured to detect a consumption current of the electronic apparatus and inform the microcontroller of the consumption current, so that the microcontroller is configured to learn (namely, be informed of) a plurality of the consumption currents, and the microcontroller is configured to determine a first amount (namely, a first number or a first quantity) of a plurality of slopes of the consumption currents. When the lithium battery charge-limiting apparatus is configured to operate in the charge-limiting mode, if the microcontroller is configured to determine that a second amount (namely, a second number or a second quantity) in the first amount of the slopes of the consumption currents are between a first minus number and zero, and if the microcontroller is configured to determine that a next slope of the slopes of the second amount of the consumption currents is greater than a present slope of the slopes of the second amount of the consumption currents, the microcontroller is configured to turn off the electronic switch, so that the electronic switch is configured to stop transmitting a charging voltage to the electronic apparatus.

Moreover, in an embodiment of the lithium battery charge-limiting apparatus of the present disclosure mentioned above, the lithium battery charge-limiting apparatus further includes a charge-limiting switch electrically connected to the microcontroller, wherein the microcontroller is configured to detect a mode state of the charge-limiting switch; if the microcontroller is configured to detect that the mode state is a charge-limiting state, the lithium battery charge-limiting apparatus is configured to operate in the charge-limiting mode.

Moreover, in an embodiment of the lithium battery charge-limiting apparatus of the present disclosure mentioned above, the lithium battery charge-limiting apparatus further includes an operating voltage source electrically connected to the microcontroller, wherein when the charge-limiting switch is configured to be switched to connect to the operating voltage source, the microcontroller is configured to detect the operating voltage source through the charge-limiting switch to determine that the mode state is the charge-limiting state.

Moreover, in an embodiment of the lithium battery charge-limiting apparatus of the present disclosure mentioned above, before the microcontroller is configured to determine the slopes of the consumption currents, the microcontroller is configured to perform a filtering process on the slopes of the consumption currents.

Moreover, in an embodiment of the lithium battery charge-limiting apparatus of the present disclosure mentioned above, the electronic apparatus further includes a lithium battery charger electrically connected to the lithium battery. When the electronic switch is configured to stop transmitting the charging voltage to the electronic apparatus, the lithium battery charger is configured to stop charging the lithium battery.

Moreover, in an embodiment of the lithium battery charge-limiting apparatus of the present disclosure mentioned above, the electronic switch includes a first metal oxide semiconductor field effect transistor and a second metal oxide semiconductor field effect transistor; the first metal oxide semiconductor field effect transistor is electrically connected to the microcontroller; the second metal oxide semiconductor field effect transistor is electrically connected to the microcontroller. Moreover, when the microcontroller is configured to turn off the electronic switch, the microcontroller is configured to turn off the first metal oxide semiconductor field effect transistor and the second metal oxide semiconductor field effect transistor.

Moreover, in an embodiment of the lithium battery charge-limiting apparatus of the present disclosure mentioned above, the lithium battery charge-limiting apparatus further includes an output port electrically connected to the electronic switch and the current detector.

Moreover, in an embodiment of the lithium battery charge-limiting apparatus of the present disclosure mentioned above, the lithium battery charge-limiting apparatus further includes a detection resistor electrically connected to the output port and the current detector, wherein the current detector is configured to detect the consumption current through the detection resistor.

Moreover, in an embodiment of the lithium battery charge-limiting apparatus of the present disclosure mentioned above, the first amount is ten; the second amount is six; the first minus number is minus one.

Moreover, in an embodiment of the lithium battery charge-limiting apparatus of the present disclosure mentioned above, the lithium battery charge-limiting apparatus further includes an alternating-current-to-direct-current converter and a power delivery communication controller; the alternating-current-to-direct-current converter is electrically connected to the microcontroller and the electronic switch; the power delivery communication controller is electrically connected to the microcontroller and the output port. Moreover, the alternating-current-to-direct-current converter is configured to generate the charging voltage.

The advantage of the present disclosure is to extend the life of the lithium battery.

Please refer to the detailed descriptions and figures of the present disclosure mentioned below for further understanding the technology, method and effect of the present disclosure achieving the predetermined purposes. It believes that the purposes, characteristic and features of the present disclosure may be understood deeply and specifically. However, the figures are only for references and descriptions, but the present disclosure is not limited by the figures.

### BRIEF DESCRIPTION OF THE DRAWINGS

FIG. 1 shows a block diagram of the first embodiment of the lithium battery charge-limiting apparatus of the present disclosure.

FIG. 2 shows a block diagram of the second embodiment of the lithium battery charge-limiting apparatus of the present disclosure.

FIG. 3 shows a schematic diagram of the charge-limiting switch of the present disclosure as the physical switch when the lithium battery charge-limiting apparatus is configured to operate in the charge-limiting mode.

FIG. 4 shows a schematic diagram of the charge-limiting switch of the present disclosure as the physical switch when the lithium battery charge-limiting apparatus is configured to operate in the charge-normal mode.

FIG. 5 shows a waveform diagram of the charging voltage of the present disclosure.

FIG. 6 shows a waveform diagram of the consumption current of the present disclosure.

FIG. 7 shows a waveform diagram of the range current average value of the present disclosure.

FIG. 8 shows a schematic diagram of the range slopes of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure may be practiced without one or more of the specific details. In other instances, well-known details are not shown or described to avoid obscuring aspects of the present disclosure. Now please refer to the figures for the explanation of the technical content and the detailed description of the present disclosure:

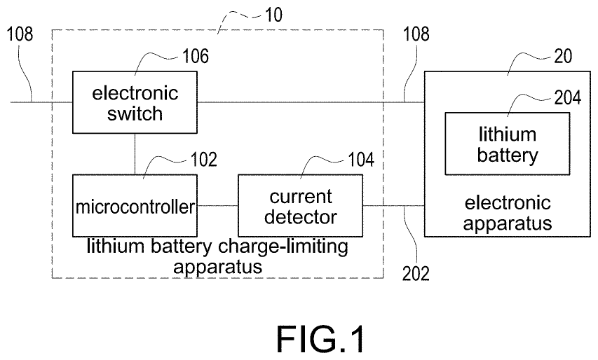

FIG. 1 shows a block diagram of the first embodiment of the lithium battery charge-limiting apparatus 10 of the present disclosure. A lithium battery charge-limiting apparatus 10 of the present disclosure is applied to an electronic apparatus 20. The electronic apparatus 20 includes a lithium battery 204. The lithium battery charge-limiting apparatus 10 includes a microcontroller 102, a current detector 104 and an electronic switch 106. The components mentioned above are electrically connected to each other.

Moreover, the electronic apparatus 20 may be, for example but not limited to, a smart phone, a notebook computer, a digital camera, or a portable electronic product; the electronic apparatus 20 uses the lithium battery 204 as a power source. When the electronic apparatus 20 receives a charging voltage 108 from the lithium battery charge-limiting apparatus 10, the electronic apparatus 20 will charge the lithium battery 204; conversely, when the electronic apparatus 20 does not receive the charging voltage 108 from the lithium battery charge-limiting apparatus 10, the electronic apparatus 20 stops charging the lithium battery 204.

When the lithium battery charge-limiting apparatus 10 is configured to operate in a charge-limiting mode (which is described in details later), the current detector 104 is configured to detect a consumption current 202 of the electronic apparatus 20 and inform the microcontroller 102 of the consumption current 202, so that the microcontroller 102 is configured to learn (namely, be informed of) a plurality of the consumption currents 202, and the microcontroller 102 is configured to determine (or calculate) a first amount (namely, a first number or a first quantity; for example but not limited to, ten) of a plurality of slopes of the consumption currents 202. Moreover, determining the first amount of the slopes of the consumption currents 202 is done by sampling from all the slopes, but the present disclosure is not limited to it.

When the lithium battery charge-limiting apparatus 10 is configured to operate in the charge-limiting mode, if the microcontroller 102 is configured to determine that a second amount (namely, a second number or a second quantity; for example but not limited to, six; namely, six of the ten mentioned above) in the first amount of the slopes of the consumption currents are between a first minus number (for example but not limited to, minus one) and zero, and if the microcontroller 102 is configured to determine that a next slope of the slopes of the second amount of the consumption currents 202 is greater than a present slope of the slopes of the second amount of the consumption currents 202 (which is described in details later), the microcontroller 102 is configured to turn off the electronic switch 106, so that the electronic switch 106 is configured to stop transmitting the charging voltage 108 to the electronic apparatus 20. Moreover, the present slope is generated before the next slope.

The reason for the above operation of the present disclosure is as follows: if the lithium battery 204 is always fully charged by the electronic apparatus 20, the life of the lithium battery 204 will be shortened, so that when the present disclosure detects that the lithium battery 204 is charged to a predetermined percentage (for example, 80%), the present disclosure stops transmitting the charging voltage 108 to the electronic apparatus 20, so that the electronic apparatus 20 stops charging the lithium battery 204. The method that the present disclosure detects that the lithium battery 204 is charged to the predetermined percentage is: first the electronic apparatus 20 will charge the lithium battery 204 in a constant current mode, then the electronic apparatus 20 will charge the lithium battery 204 in a constant voltage mode, and when the electronic apparatus 20 charges the lithium battery 204 in the constant voltage mode, the consumption current 202 will gradually decrease (namely, the slopes of the consumption currents 202 are between a first minus number and zero), and when the lithium battery 204 is charged close to the predetermined percentage, a phenomenon that the next slope is greater than the present slope will often appear (for example, the slopes are in order: −1, −0.9, −0.8, −0.7 . . . ); therefore, if there are, for example, six of ten slopes which are between the first minus number and zero, and if the next slope is greater than the present slope, the present disclosure determines that the lithium battery 204 has been charged to the predetermined percentage, so that the present disclosure stops transmitting the charging voltage 108 to the electronic apparatus 20, such that the electronic apparatus 20 stops charging the lithium battery 204.

Moreover, the microcontroller 102 may be, for example but not limited to, a microcontroller (or called MCU) with the model number EFM8BB2 produced by Silicon Labs, or the microcontroller 102 may be a microcontroller of any model number produced by any other manufacturers, to perform the above-mentioned determination of the slopes of the consumption currents 202 and to control the electronic switch 106; it should be noted that for any microcontroller, it is not difficult to calculate to determine the slopes of a plurality of data, and the control of the electronic switch is also an inherent technology, such as the above-mentioned microcontroller with the model number EFM8BB2.

The data and diagrams of all the embodiments described below are measured on a smartphone with a model number iPhone 12 produced by the smartphone manufacturer Apple Computer, and the lithium battery starts to be charged at 60%, and the charging uses the USB Type-C to convert to the Lightning Cable, but the present disclosure is not limited by this. The following embodiment describes how to calculate the above-mentioned slopes to determine whether to turn off the electronic switch 106:

From the 20th second, the consumption current 202 is obtained every sampling time (for example, 3 minutes); namely, the first consumption current 202 is obtained at the 20th second, the second consumption current 202 is obtained at the third minute and the 20th second, the third consumption current 202 is obtained at the 6th minute and the 20th second, and so on; the 28th consumption current 202 is obtained at the first hour, the 21th minute and the 20th second; the first consumption current 202 to the 28th consumption current 202 are respectively 1.6105 amperes, 1.4257 amperes, 1.1231 amperes, 1.1222 amperes, 1.1796 amperes, 0.9511 ampere, 0.7647 ampere, 1.2351 amperes, 1.0997 amperes, 1.1019 amperes, 1.0853 amperes, 1.7265 amperes, 0.8956 ampere, 0.7438 ampere, 0.6304 ampere, 0.5474 ampere, 0.4794 ampere, 0.4207 ampere, 0.6009 ampere, 0.3881 ampere, 0.302 ampere, 0.3576 ampere, 0.2504 ampere, 0.2305 ampere, 0.3397 ampere, 0.1764 ampere, 0.1741 ampere and 0.1009 ampere.

Continuing from the above, the slope is defined as the change of the variable on the y-axis divided by the change of the variable on the x-axis, and the change of the variable on the x-axis is 3 minutes, so in order to facilitate the understanding of the present disclosure, the change of the variable on the x-axis is simplified as 1; namely, the change of the time on the x-axis of the slopes is fixed to 1, so that the first slope is 1.4257−1.6105=−0.1848, the second slope is 1.1231−1.4257=−0.3026, and so on; the first slope to the 27th slope are respectively −0.1848, −0.3026, −0.0009, 0.0574, −0.2285, −0.1864, 0.4704, −0.1354, 0.0022, −0.0166, 0.6412, −0.8309, −0.1518, −0.1134, −0.083, −0.068, −0.0587, 0.1802, −0.2128, −0.0861, 0.0556, −0.1072, −0.0199, 0.1092, −0.1633, −0.0023 and −0.0732.

Continuing from the above, among these 27 slopes, take out ten consecutive slopes, which are −0.1518 (at the 39th minute and the 20th second), −0.1134 (at the 42nd minute and the 20th second), −0.083 (at the 45th minute and the 20th second), −0.068 (at the 48th minute and the 20th second), −0.0587 (at the 51st minute and the 20th second), 0.1802 (at the 54th minute and the 20th second), −0.2128 (at the 57th minute and the 20th second), −0.0861 (at the first hour, the 0th minute and the 20th second), 0.0556 (at the first hour, the 3rd minute and the 20th second), −0.1072 (at the first hour, the 6th minute and the 20th second), wherein the following 7 slopes: −0.1518 (at the 39th minute and the 20th second), −0.1134 (at the 42rd minute and the 20th second), −0.083 (at the 45th minute and the 20th second), −0.068 (at the 48th minute and the 20th second), −0.0587 (at the 51st minute and the 20th second), −0.2128 (at the 57th minute and the 20th second) and −0.0861 (at the first hour, the 0th minute and the 20th second) are all between minus one and zero, and the next slope is greater than the present slope, representing that the lithium battery 204 has been charged to about 80% at this time (for example but not limited to, the 57th minute and the 20th second), so that the electronic switch 106 should be turned off to stop charging the lithium battery 204.

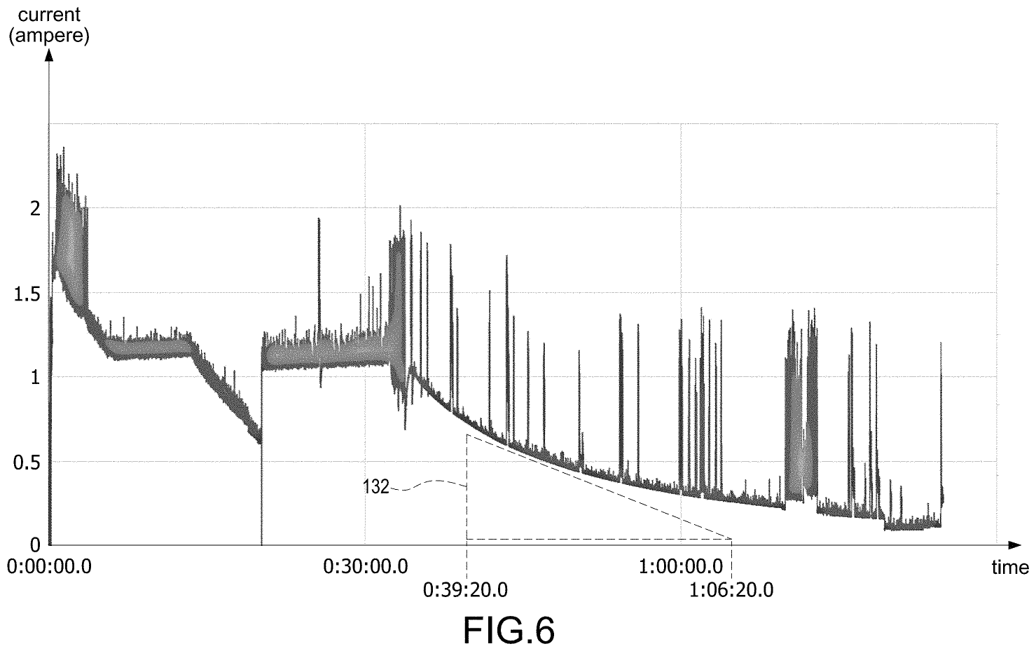

FIG. 6 shows a waveform diagram of the consumption current 202 of the present disclosure. In FIG. 6, the charging mode changes from the constant current (CC) mode to the constant voltage (CV) mode at about the 40th minute. A part indicated by a hypotenuse of a dotted triangle 132 corresponds to the 39th minute and the 20th second to the first hour, the 6th minute and the 20th second. At this time (for example but not limited to, the 57th minute and the 20th second), the lithium battery 204 has been charged to the predetermined percentage (for example, 80%), so that the present disclosure stops transmitting the charging voltage 108 to the electronic apparatus 20, such that the electronic apparatus 20 stops charging the lithium battery 204.

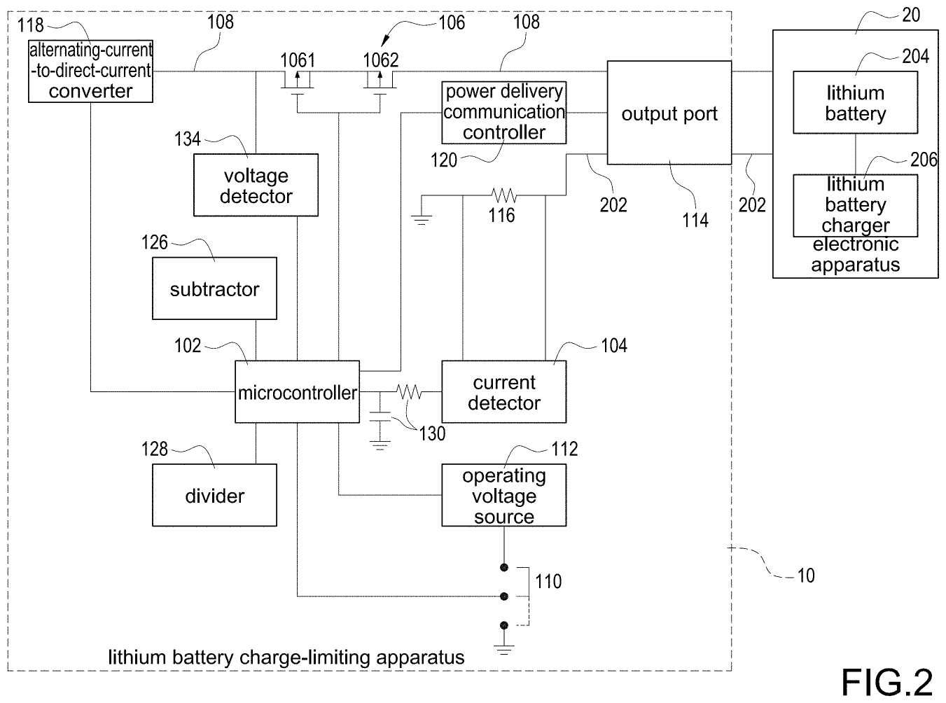

FIG. 2 shows a block diagram of the second embodiment of the lithium battery charge-limiting apparatus 10 of the present disclosure. The descriptions of the elements shown in FIG. 2 which are the same as the elements shown in FIG. 1 are not repeated here for brevity. The lithium battery charge-limiting apparatus 10 further includes a charge-limiting switch 110, an operating voltage source 112, an output port 114, a detection resistor 116, an alternating-current-to-direct-current converter 118 and a power delivery communication controller 120. The electronic switch 106 includes a first metal oxide semiconductor field effect transistor 1061 and a second metal oxide semiconductor field effect transistor 1062. The electronic apparatus 20 further includes a lithium battery charger 206. The components mentioned above are electrically connected to each other.

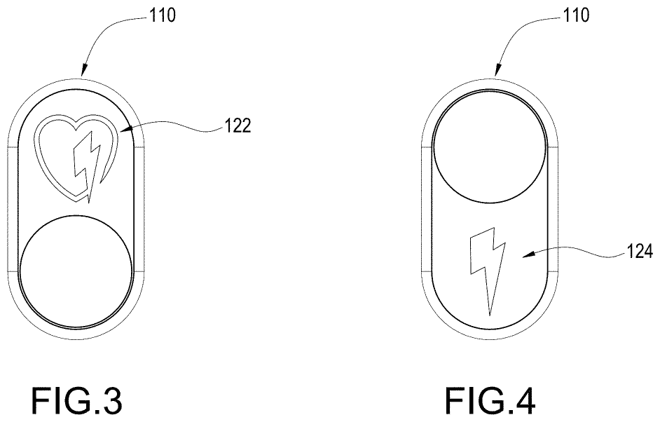

Moreover, the charge-limiting switch 110 may be, for example but not limited to, a physical switch arranged on a housing (not shown in FIG. 2) of the lithium battery charge-limiting apparatus 10. FIG. 3 shows a schematic diagram of the charge-limiting switch 110 of the present disclosure as the physical switch when the lithium battery charge-limiting apparatus 10 is configured to operate in the charge-limiting mode. Namely, when the physical switch is switched to a state shown in FIG. 3, the lithium battery charge-limiting apparatus 10 is configured to operate in the charge-limiting mode, and a charge-limiting pattern 122 will be shown on the physical switch, to point out that the lithium battery charge-limiting apparatus 10 is configured to operate in the charge-limiting mode.

Moreover, the lithium battery charge-limiting apparatus 10 of the present disclosure can also be configured to operate in a charge-normal mode, so as to always transmit the charging voltage 108 to the electronic apparatus 20, so that the electronic apparatus 20 can fully charge the lithium battery 204. FIG. 4 shows a schematic diagram of the charge-limiting switch 110 of the present disclosure as the physical switch when the lithium battery charge-limiting apparatus 10 is configured to operate in the charge-normal mode. Namely, when the physical switch is switched to a state shown in FIG. 4, the lithium battery charge-limiting apparatus 10 is configured to operate in the charge-normal mode, and a charge-normal pattern 124 will be shown on the physical switch, to point out that the lithium battery charge-limiting apparatus 10 is configured to operate in the charge-normal mode.

Please refer to FIG. 2 again. The microcontroller 102 is configured to detect a mode state of the charge-limiting switch 110. When the charge-limiting switch 110 is configured to switch to connect to the operating voltage source 112 (namely, the physical switch is switched to the state shown in FIG. 3), the microcontroller 102 is configured to detect the operating voltage source 112 through the charge-limiting switch 110 to determine that the mode state is a charge-limiting state. If the microcontroller 102 is configured to detect that the mode state is the charge-limiting state, the lithium battery charge-limiting apparatus 10 is configured to operate in the charge-limiting mode. In other words, first the charge-limiting switch 110 is switched to connect to the operating voltage source 112 (at this time, the physical switch is switched to the state shown in FIG. 3), and then the microcontroller 102 detects the operating voltage source 112 through the charge-limiting switch 110 to determine that the mode state is the charge-limiting state, and then the lithium battery charge-limiting apparatus 10 is configured to operate in the charge-limiting mode. Moreover, similar to the above content, any microcontroller (for example but not limited to, the above-mentioned microcontroller with the model number EFM8BB2) can detect the presence of the voltage source; for example, the microcontroller uses a built-in voltage detector to detect the voltage source.

Moreover, in another embodiment of the present disclosure, first the charge-limiting switch 110 is switched to connect to a ground (at this time, the physical switch is switched to the state shown in FIG. 4), and then the microcontroller 102 detects the ground through the charge-limiting switch 110 to determine that the mode state is a charge-normal state, and then the lithium battery charge-limiting apparatus 10 is configured to operate in the charge-normal mode. Similar to the above content, any microcontroller (for example but not limited to, the above-mentioned microcontroller with the model number EFM8BB2) can detect the presence of the ground (namely, 0-volt voltage); for example, the microcontroller uses the built-in voltage detector to detect the ground.

When the electronic switch 106 is configured to stop transmitting the charging voltage 108 to the electronic apparatus 20, the lithium battery charger 206 is configured to stop charging the lithium battery 204. Moreover, when the electronic switch 106 is configured to transmit the charging voltage 108 to the electronic apparatus 20, the lithium battery charger 206 is configured to charge the lithium battery 204. The lithium battery charger 206 may be, for example but not limited to, a lithium battery charging circuit which is built in the electronic apparatus 20.

When the microcontroller 102 is configured to turn off the electronic switch 106, the microcontroller 102 is configured to turn off the first metal oxide semiconductor field effect transistor 1061 and the second metal oxide semiconductor field effect transistor 1062. The current detector 104 is configured to detect the consumption current 202 through the detection resistor 116. The alternating-current-to-direct-current converter 118 is configured to generate the charging voltage 108.

Moreover, the first metal oxide semiconductor field effect transistor 1061 and the second metal oxide semiconductor field effect transistor 1062 may be, for example but not limited to, P-channel metal oxide semiconductor field effect transistors (P-channel MOSFETs), or any other kind of transistor switches. The electronic switch 106 may also be implemented as a relay. The operating voltage source 112 may be, for example but not limited to, a 3.3 volts voltage. The output port 114 may be, for example but not limited to, a USB Type-C hardware interface. The power delivery communication controller 120 is configured to communicate between the lithium battery charge-limiting apparatus 10 and the electronic apparatus 20; for example, the electronic apparatus 20 requests the lithium battery charge-limiting apparatus 10 to provide a 5 volts voltage or a 9 volts voltage. The power delivery communication controller 120 may be, for example but not limited to, a microcontroller or an integrated circuit, or the power delivery communication controller 120 may be directly integrated in the microcontroller 102.

Moreover, please refer to FIG. 2 again. In an embodiment of the present disclosure but not limiting the present disclosure, the lithium battery charge-limiting apparatus 10 further includes a subtractor 126 and a divider 128. The subtractor 126 is electrically connected to the microcontroller 102; the divider 128 is electrically connected to the microcontroller 102; the microcontroller 102 is configured to use the subtractor 126 and the divider 128 to determine (or calculate) the slopes of the consumption currents 202. In another embodiment of the present disclosure but not limiting the present disclosure, the subtractor 126 and the divider 128 are built in the microcontroller 102.

Before the microcontroller 102 is configured to determine the slopes of the consumption currents 202, the microcontroller 102 is configured to perform a filtering process on the consumption currents 202 and/or the slopes. Since the consumption currents 202 includes a charging current of the lithium battery charger 206 charging the lithium battery 204 and operating currents of the electronic apparatus 20 itself, filtering out large currents, for example when the electronic apparatus 20 receives text messages or performs certain operations, will be more accurate to determine whether the lithium battery 204 has been charged to the predetermined percentage, but the present disclosure is not limited by this; namely, the present disclosure can also achieve the purpose and the effect of the present disclosure without performing the filtering process. In FIG. 6, many of the particularly protruding currents are the relatively large currents of the electronic apparatus 20, for example when receiving text messages or performing certain operations.

Moreover, please refer to FIG. 2 again. The lithium battery charge-limiting apparatus 10 further includes a resistor-capacitor low pass filter 130 electrically connected to the microcontroller 102 and the current detector 104. The microcontroller 102 is configured to use the resistor-capacitor low pass filter 130 (namely, the resistor-capacitor low pass filter 130 is configured to) perform the filtering process to filter out at least one specific current which is in the consumption currents 202 and greater than a predetermined value (especially, for example a relatively large current when the electronic apparatus 20 receives text messages or performs certain operations); or, the lithium battery charge-limiting apparatus 10 does not include the resistor-capacitor low pass filter 130, but after the microcontroller 102 receives the data of the consumption currents 202, the microcontroller 102 filters out the at least one specific current which is in the consumption currents 202 and greater than the predetermined value. If a certain data of the consumption current 202 is filtered out, the present disclosure can replace it with nearby data of the consumption current 202, for example before or after 0.1 second.

Moreover, the present disclosure can also use some algorithms to perform the filtering process, which are described in details as follows:

When the microcontroller 102 is configured to perform the filtering process on the slopes of the consumption currents 202, the microcontroller 102 is configured to obtain a current minimum value of the consumption currents 202 in a previous first predetermined range of a present current of the consumption currents 202 as a range current minimum value corresponding to the present current, and then the microcontroller 102 is configured to obtain a current average value of a plurality of the range current minimum values in a previous second predetermined range of the range current minimum value as a range current average value corresponding to the range current minimum value of the present current.

The following embodiment describes a simple filtering process performed by the above algorithms:

In chronological order, there are 31 consumption currents 202, the first consumption current 202 to the 30th consumption current 202 are 0.5 ampere, but the 31st consumption current 202 is 1.5 amperes, which is obviously a relatively large current when the electronic apparatus 20 receives a text message or performs a certain operation. According to the above algorithm content, the present disclosure can filter out the 31st consumption current 202, which is described in details as follows:

The mentioned-above previous first predetermined range is ten consumption currents 202 before the present current; therefore, only the 11th consumption current 202 to the 31st consumption current 202 have the range current minimum value. The range current minimum value corresponding to the 11th consumption current 202 is 0.5 ampere (because the current minimum value among the first consumption current 202 to the 10th consumption current 202 is 0.5 ampere), the range current minimum value corresponding to the 12th consumption current 202 is 0.5 ampere (because the current minimum value among the second consumption current 202 to the 11th consumption current 202 is 0.5 ampere), and so on; the range current minimum value corresponding to the 31st consumption current 202 is 0.5 ampere (because the current minimum value among the 21st consumption current 202 to the 30th consumption current 202 is 0.5 ampere).

Then, the mentioned-above previous second predetermined range is ten range current minimum values before the range current minimum value; therefore, only the 21st consumption current 202 to the 31st consumption current 202 have the range current average value. The range current average value corresponding to the 21st consumption current 202 is 0.5 ampere (because the current average value among the 11th range current minimum value to the 20th range current minimum value is 0.5 ampere), the range current average value corresponding to the 22nd consumption current 202 is 0.5 ampere (because the current average value among the 12th range current minimum value to the 21st range current minimum value is 0.5 ampere), and so on; the range current average value corresponding to the 31st consumption current 202 is 0.5 ampere (because the current average value among the 21st range current minimum value to the 30th range current minimum value is 0.5 ampere). Therefore, the 1.5 amperes of the 31st consumption current 202 mentioned above has been filtered out.

Moreover, the microcontroller 102 is configured to determine (or calculate) the first amount (for example but not limited to, ten) of a plurality of range slopes of a plurality of the range current average values. When the lithium battery charge-limiting apparatus 10 is configured to operate in the charge-limiting mode, if the microcontroller 102 is configured to determine that the second amount of the range slopes in the first amount of the range slopes (for example but not limited to, six; namely, six of the ten mentioned above) are between the first minus number (for example but not limited to, minus one) and zero, and if the microcontroller 102 is configured to determine that a next range slope of the second amount of the range slopes is greater than a present range slope of the second amount of the range slopes (which is described in details later), the microcontroller 102 is configured to turn off the electronic switch 106, so that the electronic switch 106 is configured to stop transmitting the charging voltage 108 to the electronic apparatus 20. In other words, the above content is similar to replacing the consumption current 202 with the range current average value, so as to more accurately determine whether the lithium battery 204 has been charged to the predetermined percentage. Moreover, determining the first amount of the range slopes of the range current average values is done by sampling from all the range slopes, but the present disclosure is not limited to it. Moreover, the present range slope is generated before the next range slope.

The following embodiment describes how to calculate the range slopes mentioned above to determine whether to turn off the electronic switch 106:

First, detect the consumption current 202 every 0.1 second. If the consumption current 202 is detected from the 0th second and the previous first predetermined range and the previous second predetermined range are both 100, then the present disclosure will start to get the range current minimum value at the 10th second, and the present disclosure will start to get the range current average value at the 20th second. Then, take out the range current average value every sampling time (for example, 3 minutes); namely, take out the first range current average value at the 20th second, take out the second range current average value at the third minute and the 20th second, take out the third range current average value at the 6th minute and the 20 second, and so on; take out the 28th range current average value at the first hour, the 21st minute and the 20th second. The first range current average value to the 28th range current average value are respectively 0.000628 ampere, 1.35141 amperes, 1.10069 amperes, 1.104416 amperes, 1.119668 amperes, 0.956773 ampere, 0.753024 ampere, 1.04145 amperes, 1.052586 amperes, 1.057231 amperes, 1.071783 amperes, 0.808343 ampere, 0.896997 ampere, 0.747102 ampere, 0.633474 ampere, 0.548008 ampere, 0.478172 ampere, 0.421463 ampere, 0.37921 ampere, 0.335558 ampere, 0.300356 ampere, 0.272722 ampere, 0.249173 ampere, 0.226897 ampere, 0.30116 ampere, 0.174476 ampere, 0.16279 ampere and 0.093356 ampere.

Continuing from the above, the slope is defined as the change of the variable on the y-axis divided by the change of the variable on the x-axis, and the change of the variable on the x-axis is 3 minutes, so in order to facilitate the understanding of the present disclosure, the change of the variable on the x-axis is simplified as 1; namely, the change of the time on the x-axis of the range slopes is fixed to 1, so that the first range slope is 1.35141−0.000628=1.350782, the second range slope is 1.10069−1.35141=−0.25072, and so on; the first range slope to the 27th range slope are respectively 1.350782, −0.25072, 0.003726, 0.015252, −0.162895, −0.203749, 0.288426, 0.011136, 0.004645, 0.014552, −0.26344, 0.088654, −0.149895, −0.113628, −0.085466, −0.069836, −0.056709, −0.042253, −0.043652, −0.035202, −0.027634, −0.023549, −0.022276, 0.074263, −0.126684, −0.011686 and −0.069434.

Continuing from the above, among the 27 range slopes, take out ten consecutive range slopes, which are −0.149895 (at the 39th minute and the 20th second), −0.113628 (at the 42nd minute and the 20th second), −0.085466 (at the 45th minute and the 20th second), −0.069836 (at the 48th minute and the 20th second), −0.056709 (at the 51st minute and the 20th second), −0.042253 (at the 54th minute and the 20th second), −0.043652 (at the 57th minute and the 20th second), −0.035202 (at the first hour, the 0th minute and the 20th second), −0.027634 (at the first hour, the third minute and the 20th second), −0.023549 (at the first hour, the 6th minute and the 20th second), wherein the following 8 range slopes: −0.149895 (at the 39th minute and the 20th second), −0.113628 (at the 42th minute and the 20th second), −0.085466 (at the 45th minute and the 20th second), −0.069836 (at the 48th minute and the 20th second), −0.056709 (at the 51st minute and the 20th second), −0.043652 (at the 57th minute and the 20th second), −0.035202 (at the first hour, the 0th minute and the 20th second), −0.027634 (at the first hour, the third minute and the 20th second) are between minus one and zero, and the next range slope is greater than the present range slope, representing that the lithium battery 204 has been charged to approximately 80% at this time (for example but not limited to, the 57th minute and the 20th second), so that the electronic switch 106 should be turned off to stop charging the lithium battery 204.

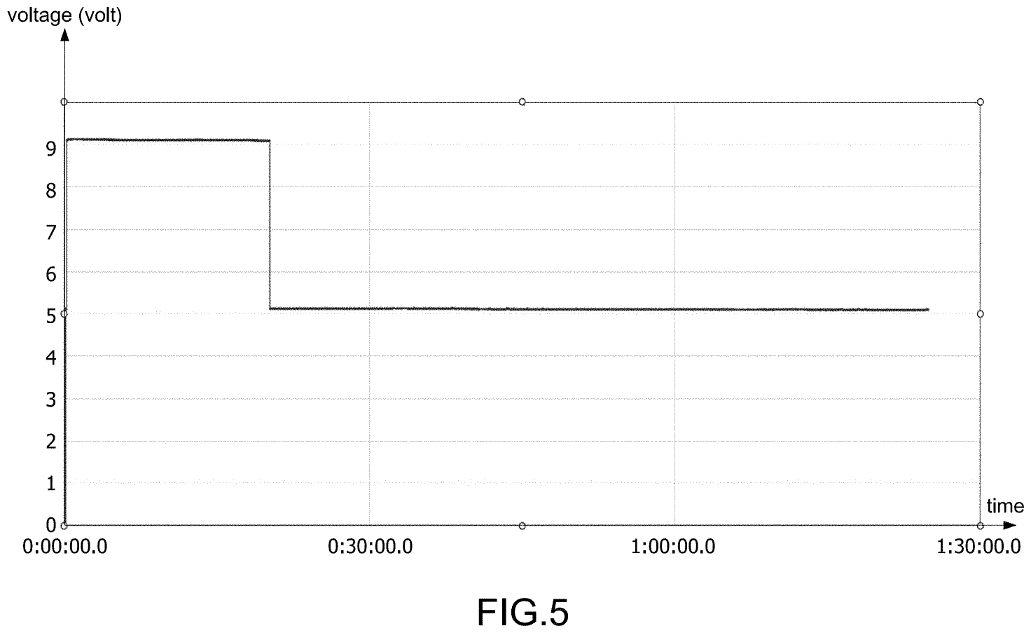

Moreover, please refer to FIG. 2 again. The lithium battery charge-limiting apparatus 10 further includes a voltage detector 134 electrically connected to the microcontroller 102, the alternating-current-to-direct-current converter 118 and the electronic switch 106. The voltage detector 134 is configured to detect the charging voltage 108 to inform the microcontroller 102 of the charging voltage 108. FIG. 5 shows a waveform diagram of the charging voltage 108 of the present disclosure. Please refer to FIG. 2 and FIG. 5 at the same time. The lithium battery charge-limiting apparatus 10 initially provides about 9 volts (for fast charging) of the charging voltage 108 to the electronic apparatus 20, and then the lithium battery charge-limiting apparatus 10 provides about 5 volts of the charging voltage 108 to the electronic apparatus 20. As described above, the power delivery communication controller 120 is configured to communicate between the lithium battery charge-limiting apparatus 10 and the electronic apparatus 20; for example, the electronic apparatus 20 requests the lithium battery charge-limiting apparatus 10 to provide a 5 volts voltage or a 9 volts voltage.

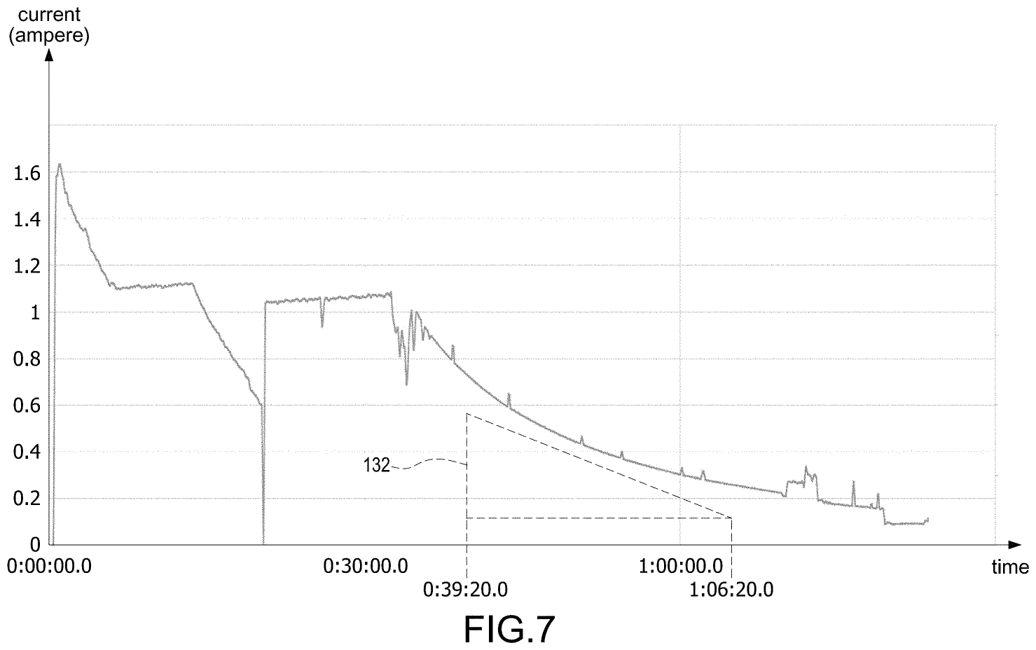

FIG. 7 shows a waveform diagram of the range current average value of the present disclosure. In FIG. 7, the charging mode changes from the constant current (CC) mode to the constant voltage (CV) mode at about the 40th minute. The part indicated by the hypotenuse of the dotted triangle 132 corresponds to the 39th minute and the 20th second to the first hour, the 6th minute and the 20th second. At this time (for example but not limited to, the 57th minute and the 20th second), the lithium battery 204 has been charged to the predetermined percentage (for example, 80%), so that the present disclosure stops transmitting the charging voltage 108 to the electronic apparatus 20, such that the electronic apparatus 20 stops charging the lithium battery 204.

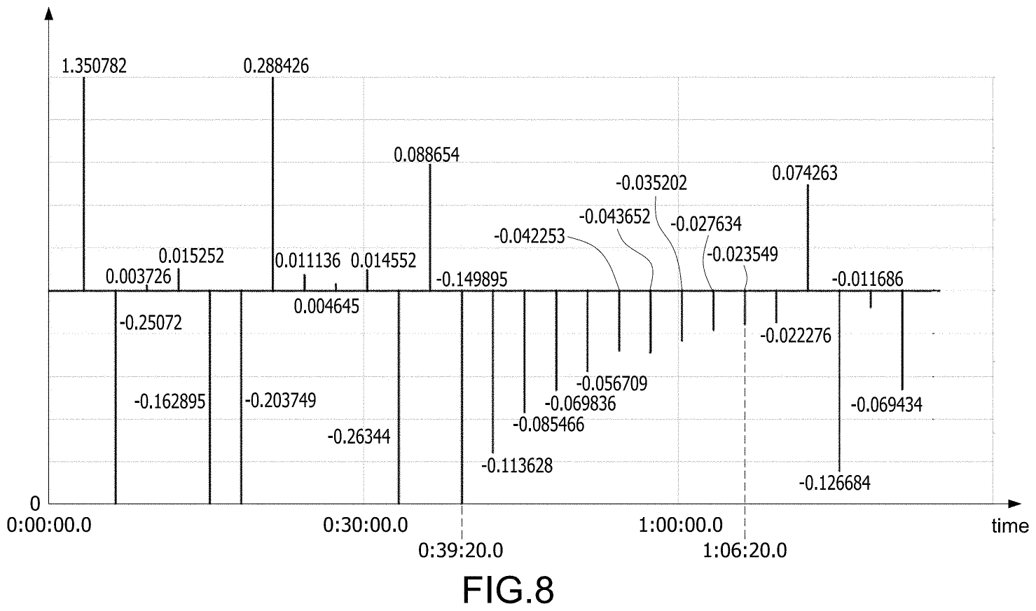

FIG. 8 shows a schematic diagram of the range slopes of the present disclosure. It should be noted that the magnitudes of the range slopes shown in FIG. 8 are not drawn to scale, but the values of the mentioned-above embodiment are indicated beside the range slopes for reference.

In summary, the present disclosure provides an optimized battery charging solution. The advantage of the present disclosure is to extend the life of the lithium battery. For example, the present disclosure is able to double the life of the lithium battery. Moreover, besides the above-mentioned definition of the slope as the change of the variable on the y-axis divided by the change of the variable on the x-axis, since the waveform of the consumption current 202 and the waveform of the range current average value are both curves, the present disclosure may also use the tangent slope (calculated by differential) to replace the slope and the range slope mentioned above.

Although the present disclosure has been described with reference to the embodiment thereof, it will be understood that the disclosure is not limited to the details thereof. Various substitutions and modifications have been suggested in the mentioned-above description, and others will occur to those of ordinary skill in the art. Therefore, all such substitutions and modifications are intended to be embraced within the scope of the disclosure as defined in the appended claims.

What is claimed is:

1. A lithium battery charge-limiting apparatus applied to an electronic apparatus, the electronic apparatus comprising a lithium battery, the lithium battery charge-limiting apparatus comprising:
a microcontroller;
a current detector electrically connected to the microcontroller; and
an electronic switch electrically connected to the microcontroller,
wherein when the lithium battery charge-limiting apparatus is configured to operate in a charge-limiting mode, the current detector is configured to detect a consumption current of the electronic apparatus and inform the microcontroller of the consumption current, so that the microcontroller is configured to learn a plurality of the consumption currents, and the microcontroller is configured to determine a first amount of a plurality of slopes of the consumption currents; when the lithium battery charge-limiting apparatus is configured to operate in the charge-limiting mode, if the microcontroller is configured to determine that a second amount in the first amount of the slopes of the consumption currents are between a first minus number and zero, and if the microcontroller is configured to determine that a next slope of the slopes of the second amount of the consumption currents is greater than a present slope of the slopes of the second amount of the consumption currents, the microcontroller is configured to turn off the electronic switch, so that the electronic switch is configured to stop transmitting a charging voltage to the electronic apparatus.

2. The lithium battery charge-limiting apparatus of claim 1, further comprising:
a charge-limiting switch electrically connected to the microcontroller,
wherein the microcontroller is configured to detect a mode state of the charge-limiting switch; if the microcontroller is configured to detect that the mode state is a charge-limiting state, the lithium battery charge-limiting apparatus is configured to operate in the charge-limiting mode.

3. The lithium battery charge-limiting apparatus of claim 2, further comprising:
an operating voltage source electrically connected to the microcontroller,
wherein when the charge-limiting switch is configured to be switched to connect to the operating voltage source, the microcontroller is configured to detect the operating voltage source through the charge-limiting switch to determine that the mode state is the charge-limiting state.

4. The lithium battery charge-limiting apparatus of claim 3, wherein before the microcontroller is configured to determine the slopes of the consumption currents, the microcontroller is configured to perform a filtering process on the slopes of the consumption currents.

5. The lithium battery charge-limiting apparatus of claim 4, wherein the electronic apparatus further comprises a lithium battery charger electrically connected to the lithium battery; when the electronic switch is configured to stop transmitting the charging voltage to the electronic apparatus, the lithium battery charger is configured to stop charging the lithium battery.

6. The lithium battery charge-limiting apparatus of claim 5, wherein the electronic switch comprises:
a first metal oxide semiconductor field effect transistor electrically connected to the microcontroller; and
a second metal oxide semiconductor field effect transistor electrically connected to the microcontroller,
wherein when the microcontroller is configured to turn off the electronic switch, the microcontroller is configured to turn off the first metal oxide semiconductor field effect transistor and the second metal oxide semiconductor field effect transistor.

7. The lithium battery charge-limiting apparatus of claim 6, further comprising:
an output port electrically connected to the electronic switch and the current detector.

8. The lithium battery charge-limiting apparatus of claim 7, further comprising:
a detection resistor electrically connected to the output port and the current detector,
wherein the current detector is configured to detect the consumption current through the detection resistor.

9. The lithium battery charge-limiting apparatus of claim 8, wherein the first amount is ten; the second amount is six; the first minus number is minus one.

10. The lithium battery charge-limiting apparatus of claim 9, further comprising:
an alternating-current-to-direct-current converter electrically connected to the microcontroller and the electronic switch; and
a power delivery communication controller electrically connected to the microcontroller and the output port,
wherein the alternating-current-to-direct-current converter is configured to generate the charging voltage.
